(19) United States
(12) Patent Application Publication
(10) Pub. No.: US 2026/0298546 A1
(43) Pub. Date: Oct. 1, 2026

(54) ADDITIVELY MANAUFACTURED HEAT EXCHANGER

(71) Applicant: MAHLE International GmbH, Stuttgart (DE)

(72) Inventors: Boris Kerler, Stuttgart (DE); Marco Renz, Esslingen (DE); Volker Velte, Oetisheim (DE)

(21) Appl. No.: 19/163,838

(22) PCT Filed: Feb. 5, 2024
(86) PCT No.: PCT/EP2024/052759

§ 371 Date: Sep. 29, 2025

(30) Foreign Application Priority Data
Mar. 10, 2023 (DE) 102023202186.2

(51) Int. Cl. F28D 7/00; B33Y 80/00

(52) U.S. Cl. CPC F28D 7/0008; B33Y 80/00

(57) ABSTRACT

An additively manufactured heat exchanger for media-separated heat transfer between a first fluid and a second fluid is disclosed. The heat exchanger includes an additively manufactured heat exchanger block, a plurality of first flow channels for conducting the first fluid, a first chamber disposed on the heat exchanger block at a first transverse end, a second chamber disposed on the heat exchanger block at a second transverse end, a plurality of second flow channels for conducting the second fluid, a first connection for supplying or discharging the second fluid and a second connection for discharging or supplying the second fluid. The second flow channels are arranged next to one another in a block longitudinal direction and form a longitudinal row of channels. A plurality of longitudinal rows of channels are arranged next to one another in the block height direction within the heat exchanger block.

### CROSS REFERENCE TO RELATED APPLICATIONS

This application is a US National Phase Application of PCT/EP2024/052759, filed Feb. 5, 2024, which claims priority to German Patent Application DE-102023202186.2, filed Mar. 10, 2023, the contents both of which are hereby incorporated by reference in their entirety,

### TECHNICAL FIELD

The present invention relates to an additively manufactured heat exchanger for the media-separated heat transfer between a first fluid and a second fluid, in particular for cooling a gas.

### BACKGROUND

Additive manufacturing, especially three-dimensional printing, allows geometries to be created that cannot be achieved using conventional manufacturing methods such as casting and machining, or only with extremely high effort. Additive manufacturing can be carried out with plastics and metals.

A heat exchanger has a heat exchanger block in which a media-separated heat transfer occurs between two different fluids. In conventional designs, the heat exchanger block consists of a plurality of separate components that are assembled in a suitable manner. For example, a conventional heat exchanger block comprises a distributor pipe or distributor box and a collector pipe or collector box, which are fluidically connected to each other via a plurality of connecting pipes. Flowable intermediate spaces are formed between adjacent connecting pipes, in which lamellae can usually be arranged. A first fluid to be heated or cooled is passed through these intermediate spaces. A second fluid is passed through the connecting pipes to supply or discharge heat. The second fluid is supplied to the connecting pipes via the distributor pipe or distributor box. The second fluid is discharged from the connecting pipes via the collector pipe or collector box. During operation of the heat exchanger, thermal and/or mechanical stress peaks occur, particularly at the transitions between the connecting pipes and the distributor pipe or the collector pipe, which the heat exchanger block must be able to tolerate. This inevitably results in the heat exchanger block being oversized in many places. Furthermore, the heat transfer performance of a heat exchanger correlates with the surface area available for heat transfer. The number of connection pipes that can be produced is limited by factors such as manufacturability, space requirements, and the connection technology used, which is usually a soldering method.

The present invention deals with the problem of providing an improved or at least different embodiment for a heat exchanger, which is characterized in particular by efficient heat transfer, wherein a reduction in thermal and/or mechanical stress peaks within the heat exchanger block is also sought.

The invention solves this problem by the subject matter of the independent claim(s). Advantageous embodiments are the subject-matter of the dependent claims.

### SUMMARY

The invention is based on the general idea of additive manufacturing the heat exchanger block in such a way that a plurality of first flow channels for conducting a first fluid are formed in the heat exchanger block, which penetrate the heat exchanger block in one direction, for example in the block longitudinal direction or in the block transverse direction, so that the first fluid can flow through the heat exchanger block in the direction defined by these channels in the first flow channels. Furthermore, a first chamber is formed on the heat exchanger block at a first transverse end, which extends, for example, in the block height direction. The heat exchanger has a first connection for supplying or discharging a second fluid. In addition, a second chamber is formed on the heat exchanger block at a second transverse end facing away from the first transverse end in the block transverse direction, which chamber extends in the block height direction. The heat exchanger has a second connection for discharging or supplying the second fluid. In addition, a plurality of second flow channels for conducting the second fluid are formed in the heat exchanger block, which are fluidically separated from the first flow channels, which penetrate the heat exchanger block in the block transverse direction and which fluidically connect the first chamber to the second chamber. The additive manufacturing of the heat exchanger block makes it possible to arrange a plurality of second flow channels in the heat exchanger block in the block longitudinal direction, either next to each other or one behind the other, to form a longitudinal row of channels. A plurality of such longitudinal rows of channels are then arranged next to each other in the block height direction within the heat exchanger block. For example, in the respective longitudinal row of channels, at least three, preferably at least five, and in particular at least ten connecting channels may be arranged next to one another in the block longitudinal direction. Compared to a conventionally manufactured heat exchanger block, in which a maximum of two connecting pipes are arranged next to each other in the block longitudinal direction, the design proposed here results in an extreme increase in the surface area available for heat transfer while requiring the same amount of installation space. Furthermore, in the additive design, more material in the heat exchanger block is available for heat transfer, since the second flow channels and the first flow channels pass through the material of the heat exchanger block. In contrast, in conventional designs, the material of the heat exchanger block is formed exclusively by the pipe walls of the connecting pipes and by the walls of any fins arranged between the connecting pipes. This means that more material is available for heat transfer in the additively manufactured heat exchanger block.

Whereas in conventional production of the heat exchanger block, the connecting pipes penetrate a side wall that delimits the distributor pipe or the distributor box or the collector pipe or the collector box and thus protrude into the interior of the distributor pipe/distributor box or the collector pipe/distributor box and form a flow obstacle there, such a protrusion is not necessary in additive manufacturing, which results in a significant reduction in the flow resistance of the heat exchanger for the second fluid.

Such a heat exchanger can be used, for example, at a hydrogen filling station to cool the hydrogen when filling a vehicle tank.

According to an advantageous embodiment, the heat exchanger block has a block longitudinal center plane extending transversely to the block longitudinal direction, which extends centrally through the heat exchanger block with respect to the block longitudinal direction. In addition, the connecting channels can be configured with regard to their flow resistance such that, in the respective longitudinal row of channels, the magnitude of the flow resistance of the respective second flow channel correlates with the distance of the respective second flow channel from the block longitudinal center plane, so that the second flow channels that are further away from the block longitudinal center plane have a greater flow resistance than second flow channels that are closer to the block longitudinal center plane. This measure ensures that during operation of the heat exchanger, the volume flow of the second fluid is distributed unevenly to the second flow channels within the respective longitudinal row of channels, such that a larger volume flow flows through the second flow channels in the region of the block longitudinal center plane than in second flow channels that are spaced apart from the block longitudinal center plane, with the volume flow decreasing further with increasing distance from the block longitudinal center plane. This allows voltage peaks to be reduced. This design utilizes the knowledge that thermal and/or mechanical stresses at the transition between the second flow channels and the first and/or second chambers, in particular the distributor chamber and/or the collector chamber, correlate with the distance from the block longitudinal center plane. These stresses increase with increasing distance from the block longitudinal center plane. By reducing the flow rate, the stresses in the block longitudinal direction can be homogenized.

In the present context, the term “configuration” is synonymous with the term “arrangement” so that the phrase “configured in such a way that” is synonymous with the phrase “arranged in such a way that”.

A particularly useful embodiment is one in which the second flow channels are configured with regard to their flowable cross-sectional area in such a way that, in the respective longitudinal row of channels, the size of the flowable cross-sectional area of the respective second flow channel correlates with the distance of the respective second flow channel from the block longitudinal center plane, in such a way that the second flow channels that are at a greater distance from the block longitudinal center plane have a smaller flowable cross-sectional area than second flow channels that are at a smaller distance from the block longitudinal center plane. The flow resistance of the respective second flow channel correlates with the flowable cross-sectional area of the respective second flow channel. The larger the flowable cross-sectional area, the lower the flow resistance. The flow resistance can therefore be easily adjusted via the flowable cross-sectional area. Alternatively, the flow resistance of the second flow channels can also be influenced by other measures. For example, in additive manufacturing, flow obstructions such as baffles, flow guides, ribs, and nubs can be incorporated into second flow channels that are designed to have higher flow resistance.

The heat exchanger block has a central transverse region which is spaced apart from the first transverse end and the second transverse end and which merges into the first chamber via a first transition region at the first transverse end and merges into the second chamber via a second transition region at the second transverse end. The configuration of the second flow channels described above with regard to their flowable cross-sectional area applies preferably at least in the central transverse region, since this is where the greatest influence on the flow resistance occurs over the length of the second flow channels measured in the block transverse direction. The configuration of the second flow channels described above is also suitable in terms of their flowable cross-sectional area in the first transition region connecting the first chamber to the central transverse region. Optionally, the configuration of the second flow channels described above with regard to their flowable cross-sectional area can also apply to the second transition region, which connects the central transverse region to the second chamber.

According to an advantageous embodiment, the first chamber may form or comprise a distributor chamber which supplies the second fluid to the second flow channels, wherein the first connection forms a supply connection for supplying the second fluid to the distributor chamber. The heat exchanger block may have a block longitudinal center plane extending transversely to the block longitudinal direction, which extends centrally through the heat exchanger block with respect to the block longitudinal direction. Furthermore, the second flow channels on the distributor chamber can each have an inlet opening with a flowable round inlet cross-section. These round inlet cross-sections have a longitudinal diameter measured in the block longitudinal direction and a height diameter measured in the block height direction. The second flow channels can now be configured with regard to their inlet cross-section so that, in the respective longitudinal row of channels, the size of the longitudinal diameter of the inlet cross-section of the inlet opening of the respective second flow channel correlates with the distance of the respective second flow channel from the block longitudinal center plane, in such a way that the second flow channels that are further away from the block longitudinal center plane have an inlet cross-section with a larger longitudinal diameter than second flow channels that are closer to the block longitudinal center plane. In other words, the inlet cross-sections of the inlet openings become larger and larger in terms of their longitudinal diameter as the distance from the block longitudinal center plane increases. This measure helps reduce thermal and/or mechanical stress peaks.

A configuration in which the longitudinal diameter of the inlet cross-sections is at least as large as the height diameter at all inlet openings is advantageous. In particular, the inlet cross-sections can be circular or elliptical.

According to an advantageous embodiment, the height diameter of the inlet cross-section of the inlet opening of the respective second flow channel can be the same for all second flow channels of the respective longitudinal row of channels. As a result, the inlet cross-sections of the inlet openings of second flow channels, which are spaced apart from the block longitudinal center plane, are flat or elongated. Furthermore, the inlet cross-sectional areas of the inlet openings of the second flow channels arranged in the region of the block longitudinal center plane may be circular, while the inlet cross-sections of the inlet openings of the second flow channels spaced apart from the block longitudinal center plane are elliptical, wherein the elliptical cross-sections become increasingly flatter or more elongated as the distance of the second flow channels from the block longitudinal center plane increases.

According to another embodiment, the second chamber may be designed to form or include a collector chamber that receives the second fluid coming from the second flow channels, in which case the second connection forms a discharge connection for discharging the second fluid from the collector chamber.

Preferably, the above statements regarding the transition between the distributor chamber and the second flow channels also apply to the transition from the second flow channels to the collector chamber. Accordingly, the second flow channels on the collector chamber each have an outlet opening with a flowable round outlet cross-section, wherein the outlet cross-sections have a longitudinal diameter measured in the block longitudinal direction and a height diameter measured in the block height direction. The second flow channels are now configured in terms of their outlet cross-section so that, in the respective longitudinal row of channels, the size of the longitudinal diameter of the outlet cross-section of the respective second flow channel correlates with the distance of the respective second flow channel from the block longitudinal center plane, so that the second flow channels that are at a greater distance from the block longitudinal center plane have an outlet cross-section with a larger longitudinal diameter than second flow channels that are at a smaller distance from the block longitudinal center plane. Preferably, it can also be provided here that the height diameter of the outlet cross-section of the respective second flow channel is the same for all second flow channels of the respective longitudinal row of channels. Here too, it may be appropriate for the longitudinal diameter to be the same as the height diameter or greater than the height diameter. This allows the outlet cross-sections in the region of the block longitudinal center plane to be circular in particular, while they can be elliptical at a distance from the block longitudinal center plane, with the elliptical cross-sections becoming increasingly flat or elongated with increasing distance from the block longitudinal center plane.

According to an advantageous embodiment, the heat exchanger block may have a central transverse region spaced apart from the first transverse end and the second transverse end. The second flow channels have a flowable cross-sectional area and can be configured such that their flowable cross-sectional area decreases from a first opening into the first chamber to the central transverse region and/or increases from the central transverse region to a second opening into the second chamber. In other words, the second flow channels have a varying flowable cross-sectional area along the block height direction. This reduces thermal and/or mechanical stress peaks at the transition between the connecting channels and the first chamber and/or the second chamber.

According to an advantageous embodiment, the heat exchanger block may have a central transverse region spaced apart from the first transverse end and the second transverse end. Furthermore, the heat exchanger block has a first transition region at the first transverse end, which connects the first chamber to the central transverse region, and a second transition region at the second transverse end, which connects the second chamber to the central transverse region. In addition, the heat exchanger block has a block longitudinal center plane that runs transversely to the block longitudinal direction. The second flow channels can now be configured so that they run parallel to the block transverse direction in the central transverse region. In addition, the second flow channels can be configured such that second flow channels spaced apart from the block longitudinal center plane run at an angle to the block transverse direction in the first transition region and/or in the second transition region, with the inclination increasing from the central transverse region to the first chamber and/or to the second chamber. This results in a fan-shaped pattern for the second flow channels in the respective transition region. This design has proven to reduce thermal and/or mechanical stress peaks in the respective transition region.

According to an advantageous embodiment, the heat exchanger block has a central transverse region spaced apart from the first transverse end and the second transverse end, wherein the heat exchanger block has a first transition region connecting the first chamber to the central transverse region at the first transverse end and a second transition region connecting the second chamber to the central transverse region at the second transverse end. The heat exchanger block also has a block longitudinal center plane running transversely to the block longitudinal direction. It is advantageous if the second flow channels can now be configured in such a way that at least those second flow channels which are spaced apart from or turned away from the block longitudinal center plane have a geometrically varying opening cross-section in the first transition region and/or in the second transition region along the block transverse direction. The second flow channels facing away from the block longitudinal center plane are those second flow channels that have the greatest distance from the block longitudinal center plane within the respective longitudinal row of channels. The geometrically varying opening cross-section reduces thermal and/or mechanical stress peaks in the respective transition region.

According to an advantageous further development, at least the second flow channels, which are spaced apart from or turned away from the block longitudinal center plane, have a geometrically constant opening cross-section along the block transverse direction in the central transverse region. In other words, the opening cross-sections of the second flow channels are constant along the block transverse direction in the central transverse region, while they vary in the two transition regions.

In principle, an embodiment is preferred in which the second flow channels of the respective longitudinal row of channels extend separately from the first chamber to the second chamber and have separate inlet and outlet openings there. In another embodiment, however, it may be provided that the flow channels of the respective longitudinal row of channels run separately from one another at least in a central transverse region of the heat exchanger block, which is spaced apart from the first transverse end and the second transverse end, while in a first transition region of the heat exchanger block, which leads to the first chamber, and/or in a second transition region of the heat exchanger block leading to the second chamber, they are combined to form a common channel.

According to another further development, at least the second flow channels, which are spaced apart from or turned away from the block longitudinal center plane, in a first opening into the first chamber have an elliptical opening cross-section which is elongated in the block longitudinal direction and which merges into a circular opening cross-section along the block transverse direction within the first transition region up to the central transverse region. In addition or alternatively, at least the second flow channels, which are spaced apart from or turned away from the block longitudinal center plane, have an elliptical opening cross-section in a second opening into the second chamber, which is elongated in the block longitudinal direction and merges into a circular opening cross-section along the block transverse direction within the second transition region up to the central transverse region. In particular, the elliptical first openings in the first transition region can thus merge into circular opening cross-sections, which remain circular, in particular constant, within the central transverse region and can merge again into elliptical second openings in the second transition region. The use of round cross-sections in the second flow channels, in particular elliptical and circular cross-sections, reduces thermal and/or mechanical stresses.

According to another advantageous embodiment, it may again be provided that the first chamber forms or has a distributor chamber which supplies the second fluid to the second flow channels, wherein the first connection forms a supply connection for supplying the second fluid to the distributor chamber. In this case, the distributor chamber may have a profile on a distributor side facing the connecting channels, which runs transversely to the block height direction and is concave toward the interior of the distributor chamber. In addition or as an alternative, in an embodiment in which the second chamber forms or has a collector chamber that receives the second fluid coming from the second flow channels, and in which the second connection forms a discharge connection for discharging the second fluid from the collector chamber, it may optionally be provided that the collector chamber has a profile on a collector side facing the connecting channels, which profile extends transversely to the block height direction and is concave toward the interior of the collector chamber. The concave or bent profile on the distributor side of the distributor chamber or on the collector side of the collector chamber reduces thermal and/or mechanical stress peaks.

The second flow channels, in which the geometric cross-section varies along the block transverse direction, can optionally be configured so that their flowable cross-sectional area along the block transverse direction is or remains constant.

In an advantageous embodiment, it may be provided that in a plurality of or in all first and/or second flow channels, ribs or nubs protrude into the flowable cross-section so that the ribs or nubs can be flowed onto and/or around by the second fluid. This allows the surface area available for heat transfer in the respective connection channels to be increased.

According to an advantageous embodiment, the ribs can be designed in a helical manner so that they extend in a screw-like manner along the respective second flow channel in the block transverse direction or along the respective first flow channel in the block longitudinal direction or in the block transverse direction. The helical ribs increase the surface area available for heat transfer and are characterized by comparatively low flow resistance.

According to an advantageous embodiment, the first and/or second chambers may have recesses on an inner side exposed to the second fluid in order to increase the surface area of the inner side. These recesses can significantly improve the evaporation of the refrigerant, particularly in a heat exchanger used in a refrigeration circuit where it forms an evaporator. Such recesses are also referred to as re-entry cavities.

According to an advantageous embodiment, a plurality of or all of the second flow channels may have recesses on their inner side exposed to the second fluid, at least in a transition region of the heat exchanger block adjacent to the first or second box, in order to increase the surface area of the inner side. This measure also improves heat transfer and, when used as an evaporator, supports the evaporation of the second fluid.

A particularly advantageous embodiment is one in which the recesses at the transition to the inner side have a constriction so that a cross-section of the respective recess running transversely to the normal direction of the inner side is larger within the respective recess than within the constriction. The constriction thus forms an undercut. Such recesses or under-cuts cannot be produced using conventional manufacturing methods, or only with extreme difficulty. It has been shown that recesses with such a constriction significantly support the boiling behavior of the second fluid and improve the efficiency of the heat exchanger used as an evaporator.

According to an advantageous embodiment, the heat exchanger can be designed as a cooler for cooling the first fluid using the second fluid, wherein the first fluid is a liquid cool-ant, while the second fluid is a liquid or a gas.

Alternatively, the heat exchanger can be designed as an evaporator for cooling the first fluid using the second fluid, wherein the first fluid is a two-phase refrigerant while the second fluid is a liquid or a gas. The refrigerant is two-phase because it is intended to evaporate in the evaporator, so that it is largely liquid at the supply connection and largely gaseous at the discharge connection.

As explained above, according to a preferred embodiment, the first chamber may be designed to form a distributor chamber and have the first connection, which then forms a supply connection. The second chamber then forms a collector chamber and has the second connection, which forms a discharge connection. The distributor chamber and the collector chamber are fluidically connected to each other via the second flow channels. This causes the second fluid to flow once in the block transverse direction through the heat exchanger block, namely from the distributor chamber through the second flow channels to the collector chamber. In another embodiment, however, it may be provided that the first chamber has or forms a distributor chamber and a collector chamber, in which case the first connection is formed on the distributor chamber and forms a supply connection, while the second connection is formed on the collector chamber and forms a discharge connection. In this case, the second chamber forms a deflection chamber. The deflection chamber is fluidically connected to the distributor chamber and the collector chamber via the second flow channels. In this configuration, the second fluid flows twice through the heat exchanger block, namely from the distributor chamber through a first group of second flow channels to the deflection chamber and from the deflection chamber through a second group of second flow channels to the collector chamber.

A particularly advantageous embodiment is one in which the heat exchanger is designed as a cross-flow heat exchanger, in which the first flow channels and the second flow channels are passed through the heat exchanger block according to the cross-flow principle, i.e., they cross or intersect each other in a media-separated manner. As a result, the first flow channels pass through the heat exchanger block in the block longitudinal direction and fluidically connect an inflow side of the heat exchanger block exposed to the first fluid with an outflow side of the heat exchanger block exposed to the first fluid.

According to an advantageous embodiment, a plurality of first flow channels may be arranged next to each other in the block transverse direction in the heat exchanger block and form a transverse row of channels. A plurality of transverse rows of channels are then arranged side by side in the heat exchanger block in the block height direction. The heat exchanger block has a central height range that is spaced apart from lateral block ends that are turned away from each other in the block height direction. The transverse rows of channels can now be passed through the heat exchanger block between two adjacent longitudinal rows of channels, at least in the central height range of the heat exchanger block. This results in an extremely compact design with very large surface areas for contact with the first fluid and with the second fluid. While in conventional designs, the heat exchanger block between two adjacent connecting pipes has only one flowable intermediate space in which fins can be arranged to increase the surface area, in the additively manufactured heat exchanger block, a plurality of, preferably more than ten, in particular more than twenty, first flow channels can be arranged next to each other in the block transverse direction to form the respective transverse row of channels.

As an alternative to the cross-flow design, another embodiment may provide for the heat exchanger to be designed as a parallel-flow heat exchanger, in which the first flow channels and the second flow channels are passed through the heat exchanger block according to the parallel-flow principle, i.e., they extend parallel to each other in a media-separated manner. As a result, the first flow channels pass through the heat exchanger block in the block transverse direction. In particular, it may be provided that first flow channels and second flow channels alternate in the heat exchanger block in the block height direction and/or in the block longitudinal direction. This improves the efficiency of heat transfer.

According to an advantageous embodiment, the first chamber may be provided with or form a first sub-chamber and a second sub-chamber, wherein the first sub-chamber is fluidically connected to the first flow channels, while the second sub-chamber is fluidically connected to the second flow channels. In addition, it may be provided that the second chamber has or forms a third sub-chamber and a fourth sub-chamber, wherein the third sub-chamber is fluidically connected to the first flow channels, while the fourth sub-chamber is fluidically connected to the second flow channels. It is useful for each sub-chamber to have its own connection for supplying or discharging the first or second fluid. This allows for a particularly compact design.

A particularly advantageous embodiment is one in which the first sub-chamber forms a collector chamber for the first flow channels and has a discharge connection for the first fluid, in which the second sub-chamber forms a distributor chamber for the second flow channels and has a supply connection for the second fluid, in which the third sub-chamber forms a distributor chamber for the first flow channels and has a supply connection for the first fluid, and in which the fourth sub-chamber forms a collector chamber for the second flow channels and has a discharge connection for the second fluid. This embodiment also supports a compact construction.

In the embodiment as a parallel-flow heat exchanger, it may also be provided that all first and second flow channels run parallel to each other in a central transverse region, while a plurality of or all first and second flow channels cross or intersect in a first transition region leading to the first and second sub-chambers and/or in a second transition region leading to the third and fourth sub-chambers. This also supports efficient heat transfer in a compact design.

If the heat exchanger is designed as a parallel-flow heat exchanger, all of the above-described embodiments and features relating to the second flow channels can also be implemented in a corresponding manner in the first flow channels. This applies in particular to the geometric embodiments of the openings that lead to the respective chamber or sub-chamber and/or to the variation of the flowable cross-sections in the block transverse direction within the flow channels and in the block longitudinal direction in the case of adjacent flow channels. In particular, the first flow channels in the heat exchanger block can therefore also form longitudinal rows of channels with a plurality of first flow channels adjacent to one another in the block longitudinal direction, wherein a plurality of such longitudinal rows of channels are adjacent to one another in the block height direction.

Other important features and advantages of the invention can be seen from the dependent claims, from the drawings, and from the associated description of the figure based on the drawings.

It is understood that the above-mentioned features and those yet to be explained below can be used not only in the combination indicated in the respective case, but also in other combinations or on their own, without deviating from the scope of the invention defined by the claims. The components of a superordinate unit, such as a device, an apparatus, or an arrangement, which are described separately, having been mentioned above or to be mentioned below, can represent separate components of this unit or can form integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in

FIG. 1 a greatly simplified side view of a heat exchanger,

FIG. 2 a sectional isometric view of the heat exchanger in the region of a distributor chamber,

FIG. 3 a sectional isometric view of the heat exchanger in the region of a collector chamber,

FIG. 4 an enlarged detail iv from FIG. 2,

FIG. 5 highly simplified cross-sections of second flow channels at inlet openings or outlet openings for different flow channels A and B,

FIG. 6 cross-sections as in FIG. 5, but with a different embodiment,

FIG. 7 different views of a second flow channel in a transition region from different angles A, B, C,

FIG. 8 an isometric view of a plurality of second flow channels in a transition region,

FIG. 9 an isometric view of a longitudinal section of a second flow channel or a first flow channel with ribs,

FIG. 10 a greatly simplified cross-sectional view in the region of the recesses,

FIG. 11 a greatly simplified cross-sectional view of the heat exchanger in a cross-flow embodiment,

FIG. 12 a highly simplified cross-sectional view of the heat exchanger in a parallel-flow embodiment,

FIG. 13 a greatly simplified sectional view of the heat exchanger in the region of a chamber in another embodiment.

### DETAILED DESCRIPTION

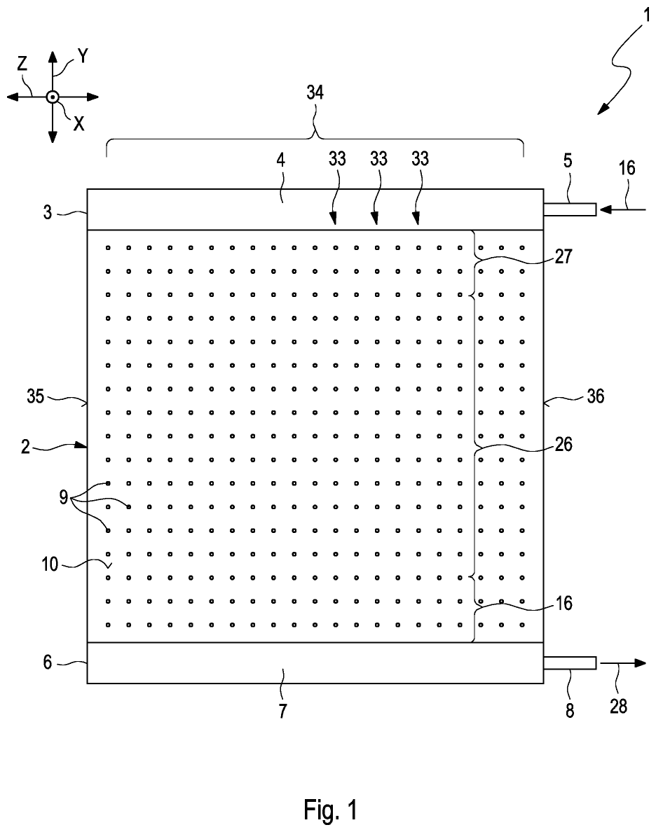

According to FIG. 1, an additively manufactured heat exchanger 1 comprises an additively manufactured heat exchanger block 2, which has a block longitudinal direction X, a block transverse direction Y, and a block height direction Z, which are perpendicular to each other. In FIG. 1, the block longitudinal direction X extends perpendicular to the drawing plane, while the block transverse direction Y runs vertically and the block height direction Z runs horizontally.

A first chamber 4 is formed on a first transverse end 3 of the heat exchanger block 2, which extends longitudinally in the block height direction Z and has a first connection 5. In the example shown here, the first chamber 4 forms a distributor chamber 4 and the first connection 5 forms a supply connection 5. A second chamber 7 is also formed on heat exchanger block 2 at a second transverse end 6, which is turned away from the first transverse end 3 in the block transverse direction Y, which chamber extends longitudinally in the block height direction Z and has a second connection 8. In the example shown here, the second chamber 7 forms a collector chamber 7 and the second connection 8 forms a discharge connection 8.

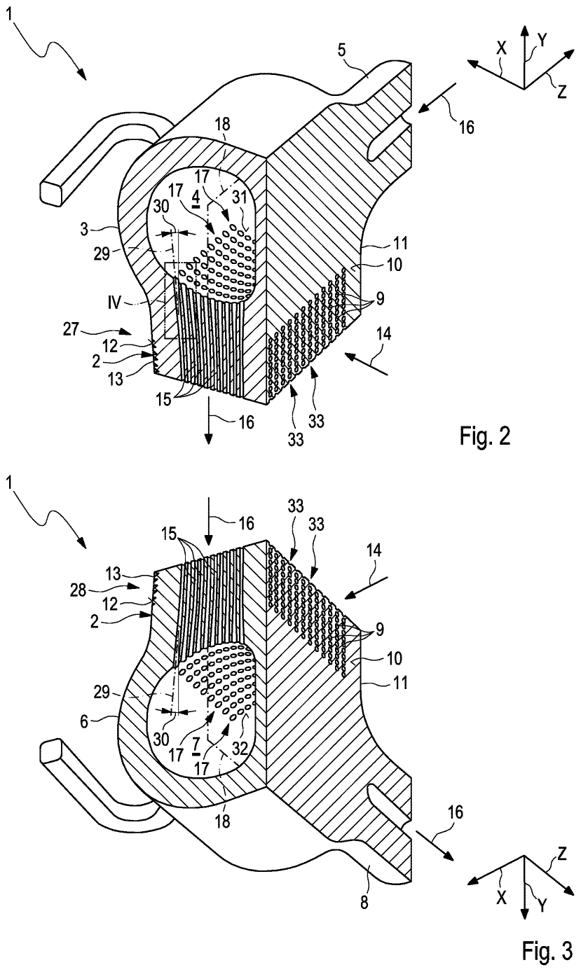

According to FIGS. 1 through 3, a plurality of first flow channels 9 for conducting a first fluid are formed in the heat exchanger block 2, which penetrate the heat exchanger block 2 in the block longitudinal direction X and fluidically connect an inflow side 10 of the heat exchanger block 2 exposed to the first fluid, which is located at a first longitudinal end 11 of the heat exchanger block 2 facing the viewer in FIGS. 1 through 3, with an outflow side 12 exposed to the first fluid, which is located at a second longitudinal end 13 of the heat exchanger block 2 facing away from the viewer in FIGS. 1 through 3. A flow of the first fluid through the heat exchanger block 2 or the first flow channels 9 during operation of the heat exchanger 1 is indicated by arrows in FIGS. 2 and 3 and designated by 14.

According to FIGS. 2 and 3, a plurality of second flow channels 15 for conducting a second fluid are also formed in the heat exchanger block 2, which are fluidically separated from the first flow channels 9. The second flow channels 15 penetrate the heat exchanger block 2 in the block transverse direction Y and connect the distributor chamber 4 fluidically to the collector chamber 7. A flow of the second fluid through the heat exchanger block 2 or the distributor chamber 4, the connecting pipes 15, and the collector chamber 7 during operation of the heat exchanger 1 is indicated by arrows in FIGS. 1 through 3 and designated by 16.

According to FIGS. 2 and 3, a plurality of second flow channels 15 are arranged next to each other in the heat exchanger block 2 in the block longitudinal direction X and form a longitudinal row of channels 17. In the example shown, each longitudinal row of channels 17 contains ten second flow channels 15. In heat exchanger block 2, a plurality of longitudinal rows of channels 17 are arranged next to each other in the block height direction Z. For example, nine such longitudinal rows of channels 17 can be seen in FIGS. 2 and 3. It is clear that in heat exchanger block 2, significantly more longitudinal rows of channels 17 can be arranged next to each other in the block height direction Z, for example more than fifty.

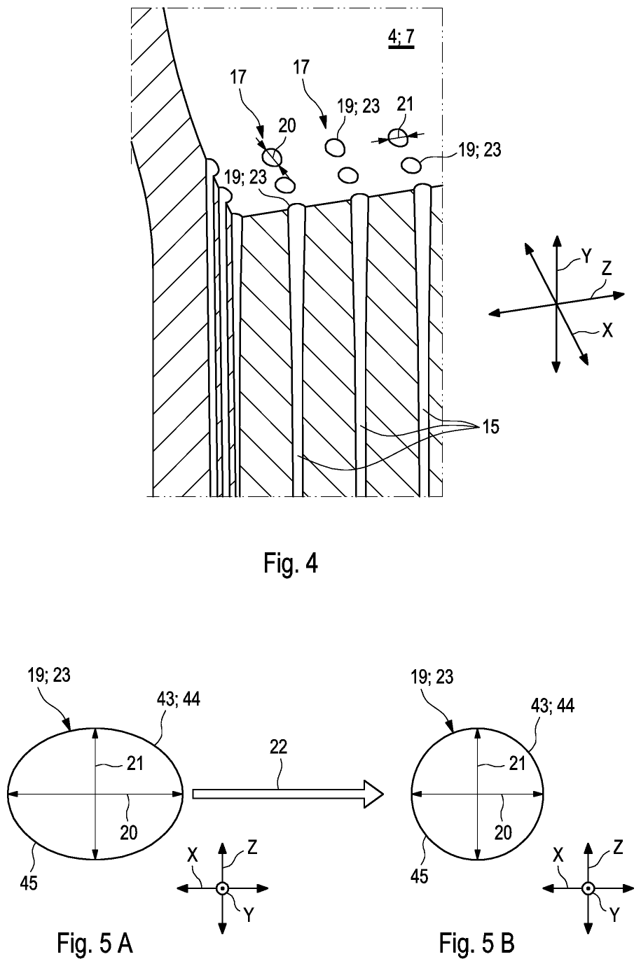

The heat exchanger block 2 has a block longitudinal center plane 18, indicated by a dotted line in FIGS. 2 and 3, which runs transversely to the block longitudinal direction X. According to FIG. 4, the second flow channels 15 each have a first opening 19 on the distributor chamber 4, which forms an inlet opening 19 and has a flowable round inlet cross-section 43. These inlet cross-sections 43 have a longitudinal diameter 20 measured in the block longitudinal direction X and a height diameter 21 measured in the block height direction Z. The second flow channels 15 are now configured with regard to their inlet cross-sections 43 such that, in the respective longitudinal row of channels 17, the size of the longitudinal diameter 20 correlates with the distance of the respective second flow channel 15 from the block longitudinal center plane 18, in such a way that the second flow channels 15 that are at a greater distance from the block longitudinal center plane 18 have an inlet cross-section 43 with a larger longitudinal diameter 20 than second flow channels 15 that are at a smaller distance from the block longitudinal center plane 18. FIG. 5 shows a purely exemplary transition from a larger longitudinal diameter of 20 to a smaller longitudinal diameter of 20. FIG. 5A shows the inlet cross-section 43 of an inlet opening 19 of a second flow channel 15, which is spaced relatively far from the block longitudinal center plane 18. In contrast, FIG. 5B shows the inlet cross-section 43 of an inlet opening 19 of a second flow channel 15, which is located relatively close to the block longitudinal center plane 18. The longitudinal diameter 20 increases noticeably with increasing distance from the block longitudinal center plane 18. A corresponding transition is indicated by an arrow in FIG. 5 and labeled 22. In the example shown, it may also be provided that the height diameter 21 of the inlet cross-section 43 of the inlet opening 19 is the same for all second flow channels 15 of the respective longitudinal row of channels 17, i.e., remains constant.

The same may also apply to the region of the collector chamber 7. For simplicity, this relationship is also explained using FIGS. 4 and 5. If the chamber shown in FIG. 4 is the collector chamber 7, the mouth openings of the second flow channels 15 are then not inlet openings 19, but second openings 23 or outlet openings 23, whose outlet cross-sections 44 also have a longitudinal diameter 20 and a height diameter 21. The second flow channels 15 are then configured with regard to their outlet cross-section 44 such that, in the respective longitudinal row of channels 17, the size of the longitudinal diameter 20 correlates with the distance of the respective second flow channel 15 from the block longitudinal center plane 18 such that the second flow channels 15 that are at a greater distance from the block longitudinal center plane 18 have an outlet cross-section 44 with a larger longitudinal diameter 20 than second flow channels 15 that are at a smaller distance from the block longitudinal center plane 18. Here too, as shown in FIGS. 5A and 5B, it may be provided that the height diameter 21 of the outlet cross-section 44 is the same for all second flow channels 15 of the respective longitudinal row of channels 17.

In the example of FIG. 5, the respective cross-section 43, 44 at the inlet openings 19 and at the outlet openings 23 is circular in the second flow channels 15 arranged close to the block longitudinal center plane 18, whereas in the second flow channels 15 spaced from the block longitudinal center plane 18, the respective cross-section 43, 44 at the inlet openings 19 and at the outlet openings 23 is elliptical.

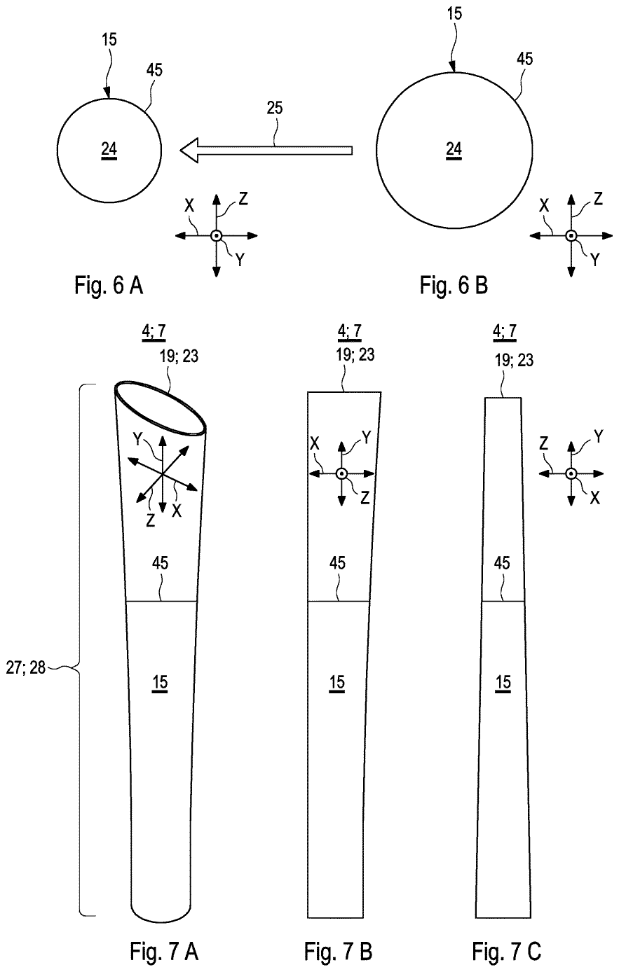

In another embodiment, which is explained in more detail in connection with FIG. 6, the second flow channels 15 can be configured with regard to their flow resistance such that, in the respective longitudinal row of channels 17, the magnitude of the flow resistance of the respective second flow channel 15 correlates with the distance of the respective second flow channel 15 from the block longitudinal center plane 18, in such a way that the second flow channels 15 that are at a greater distance from the block longitudinal center plane 18 have a greater flow resistance than second flow channels 15 that are at a smaller distance from the port block longitudinal center plane 18. It is conceivable that the flow resistance of the second flow channels 15 is increased by obstacles formed in the second flow channels 15 for this purpose. In this case, this embodiment can also be combined with the embodiments described above, in which the longitudinal diameters 20 vary in second flow channels 15 adjacent to each other in the block longitudinal direction X.

In connection with FIGS. 6A and 6B, another embodiment is explained in more detail, in which the flow resistance of the respective second flow channel 15 is varied with the aid of the flowable cross-sectional area 24 of the respective second flow channel 15. In the example shown in FIGS. 6A and 6B, the second flow channels 15 each have a circular flowable cross-section 45. It may now be expedient to provide that, in the respective longitudinal row of channels 17, the size of the flowable cross-sectional area 24 of the respective second flow channel 15 correlates with the distance of the respective second flow channel 15 from the block longitudinal center plane 18, in such a way that the second flow channels 15 that are at a greater distance from the block longitudinal center plane 18 have a smaller flowable cross-sectional area 24 than second flow channels 15 that are at a smaller distance from the block longitudinal center plane 18. FIG. 6A shows the flowable cross-sectional area 24 of a second flow channel 15, which has a comparatively large distance from the block longitudinal center plane 18, while FIG. 6B shows the flowable cross-sectional area 24 of a second flow channel 15, which has a comparatively small distance from the block longitudinal center plane 18. The flowable cross-sectional area 24 decreases significantly with increasing distance from the block longitudinal center plane 18. A corresponding transition is indicated by an arrow in FIG. 6 and labeled 25.

As shown in FIG. 1, the heat exchanger block 2 has a central transverse region 26 spaced apart from the first transverse end 3 and the second transverse end 6. Furthermore, the heat exchanger block 2 has a first transition region 27 which connects the central transverse region 26 to the distributor chamber 4. In addition, the heat exchanger block 2 has a second transition region 28 that connects the central transverse region 26 to the collector chamber 27.

The relationship described above, whereby the flowable cross-sectional area 24 of the respective second flow channel 15 decreases with increasing distance of the respective second flow channel 15 from the block longitudinal center plane 18, applies at least to the central transverse region 26 of the heat exchanger block 2. This relationship also applies in the first transition region 27 and/or in the second transition region 28.

In principle, the second flow channels 15 can be configured such that their flowable cross-sectional area 24 decreases from the inlet opening 19 into the distributor chamber 4 to the central transverse region 26 and/or increases from the central transverse region 26 to the outlet opening 23 into the collector chamber 7. It may be preferable to provide that, in the second flow channels 15, the flowable cross-sectional area 24 decreases from the inlet opening 19 within the first transition region 27 to the central transverse region 26, remains constant in the central transverse region 26, and increases from the central transverse region 26 to the outlet opening 23, i.e., within the second transition region 28. The reduction in cross-section in the central transverse region 26 also allows the flow resistance of the second flow channels 15 to be varied.

In an alternative embodiment, however, it may be provided that the second flow channels 15 have a constant flowable cross-sectional area 24 from the inlet opening 19 to the outlet opening 23, wherein the geometric flowable cross-section 45 or opening cross-section 45 may be constant or may vary.

According to FIGS. 2 and 3, the second flow channels 15 can optionally also be configured such that second flow channels 15, which are spaced apart from or turned away from the block longitudinal center plane 18, run inclined to the block transverse direction Y in the first transition region 27 or in the second transition region 28. In FIGS. 2 and 3, for each second flow channel 15 that is turned away from the block longitudinal center plane 18, i.e., within the respective longitudinal row of channels 17 at the greatest distance from the block longitudinal center plane 18, a longitudinal center axis 29 is shown, which is exemplary and representative of all other second flow channels 15 and which the respective second flow channel 15 has in its inlet opening 19 or in its outlet opening 23. This longitudinal center axis 29 has an angle of inclination 30 or an inclination 30 relative to the block transverse direction Y. The embodiment shown here is particularly advantageous, in which the inclination 30 increases from the central transverse region 26 in the first transition region 27 to the distributor chamber 4 and increases in the second transition region 28 from the central transverse region 26 to the collector chamber 7. This means that the second flow channels 15 are distributed at the distributor chamber 4 and at the collector chamber 7 in the block longitudinal direction X over a larger region than in the central transverse region 26 of the heat exchanger block 2.

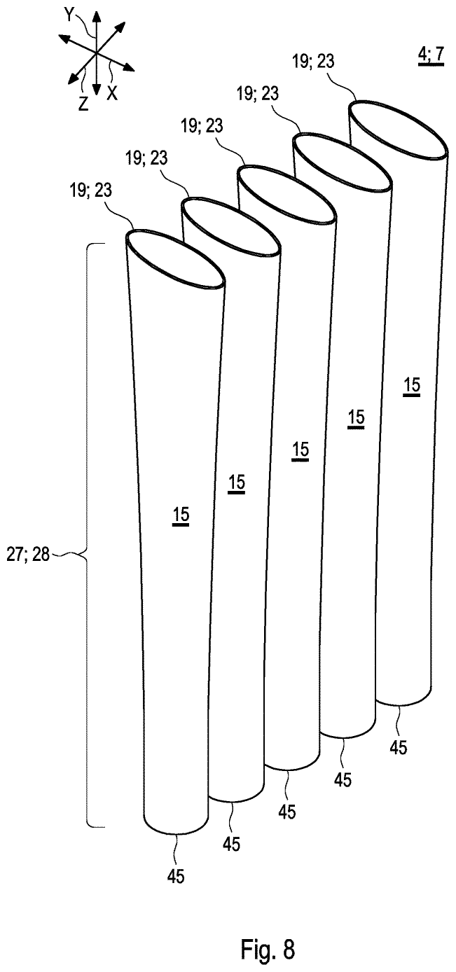

FIGS. 7 and 8 show second flow channels 15 and wall material of the heat exchanger block 2, which bounds the second flow channels 15, either in the first transition region 27 leading to the distributor chamber 4 or in the second transition region 28 leading to the collector chamber 7. FIG. 7A shows an isometric view of a second flow channel 15. FIG. 7B shows a side view of the second flow channel 15 in a direction parallel to the block height direction Z. FIG. 7C shows a side view of the second flow channel 15 in a direction parallel to the block longitudinal direction X. FIG. 8 shows an isometric view of a plurality of second flow channels 15 arranged next to each other in the block height direction Z. FIGS. 7 and 8 show second flow channels 15, which are located at a relatively large distance from the block longitudinal center plane 18. In particular, these may be the second flow channels 15 that are furthest away from the block longitudinal center plane 18.

The second flow channels 15 can now be conveniently configured so that those second flow channels 15 which are spaced apart from or turned away from the block longitudinal center plane 18 have a geometrically varying opening cross-section 45 in the first transition region 27 or in the second transition region 28 along the block transverse direction Y. In addition, the second flow channels 15 can be configured such that they have a geometrically constant opening cross-section 45 along the block transverse direction Y in the central transverse region 26. In the examples shown in FIGS. 7 and 8, the second flow channels 15 have an elliptical opening cross-section 45 in their inlet opening 19, which is elongated in the block longitudinal direction X, i.e., as shown in FIG. 5A, it has the larger longitudinal diameter 20 in the block longitudinal direction X. This elliptical opening cross-section 45 then runs along the block transverse direction Y within the first transition region 27 to the central transverse region 26, where it merges into a circular opening cross-section 45. This circular opening cross-section 45 is located in FIGS. 7 and 8 at the lower end of the section of the second flow channel 15 shown. Circular cross-sections 45 are shown purely as examples in FIGS. 5B, 6A, and 6B. The same may also apply in the second transition region 28. Then, the second flow channels 15 have an elliptical opening cross-section 45 in their outlet opening 23, which opens into the collector chamber 7, which is elongated in the block longitudinal direction X and merges into a circular opening cross-section 45 along the block transverse direction Y within the second transition region 28 up to the central transverse region 26.

As shown in FIGS. 2 and 4, the distributor chamber 4 has a profile on a distributor side 31 facing the second flow channels 15, which runs transversely to the block height direction Z and is concave toward the interior of the distributor chamber 4. The inlet openings 19 are located on the distributor side 31. According to FIGS. 3 and 4, the collector chamber 7 has a profile on a collector side 32 facing the second flow channels 15, which runs transversely to the block height direction Z and is concave toward the interior of the collector chamber 7. The outlet openings 23 are located on collector side 32. This design achieves a flow-optimized transition from the distributor chamber 4 into the second flow channels 15 and from the second flow channels 15 into the collector chamber 7, which is characterized by reduced flow resistance.

As can be seen in particular from FIGS. 1 through 3, a plurality of first flow channels 9 are arranged next to each other in the block transverse direction Y in the heat exchanger block 2 so that they form a transverse row of channels 33. For example, each transverse row of channels 33 may have more than twenty or more than fifty first flow channels 9. In heat exchanger block 2, a plurality of transverse rows of channels 33 are now arranged next to each other in the block height direction Z. According to FIG. 1, the heat exchanger block 1 has a central height range 34 which is spaced apart from lateral block ends 35, 36 which are turned away from one another in the block height direction Z. The transverse rows of channels 33 are, at least in this central height range 34, each passed through the heat exchanger block 2 between two adjacent longitudinal rows of channels 17. This results in a particularly compact arrangement of intersecting first flow channels 9 and second flow channels 15, which promotes intensive heat transfer.

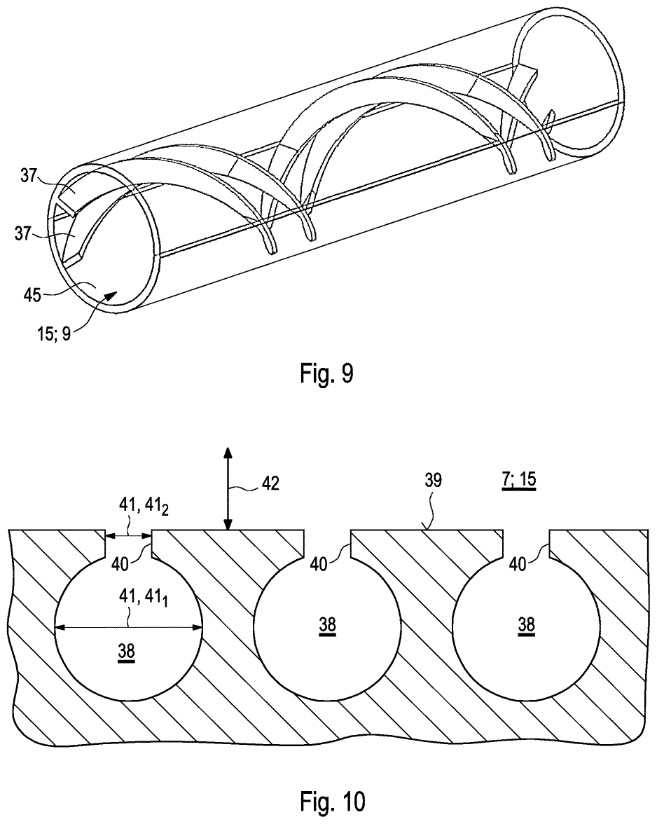

In a plurality of or in all second flow channels 15 and/or in a plurality of or in all first flow channels 9, ribs or nubs may protrude into the flowable cross-section 45 so that these ribs or nubs can be flowed onto and/or flowed around by the first fluid or the second fluid. Without limiting the generality, FIG. 9 shows an example of two helical ribs 37 extending in a screw-like manner along the respective second flow channel 15, i.e., along the block transverse direction Y, or along the respective first flow channel 9, i.e., along the block longitudinal direction X. It is clear that more than two such ribs 37 may be present in each channel 9, 15.

FIG. 10 shows recesses 38 formed on an inner side 39 exposed to the second fluid. The inner side 39 can belong to the collector chamber 7 or to the distributor chamber 4 or to one of the second flow channels 15, preferably in the first transition region 27 or in the second transition region 28. The recesses 38 increase the surface area of the respective inner side 39. For example, the recesses 38 at the transition to the inner side 39 may have a constriction 40. As a result, a cross-section 41 of the respective recess 38 within the respective recess 38 is larger than within the constriction 40. The cross-section 41 is measured transversely to a normal direction 42 of the inner side 39, which is perpendicular to the inner side 39. In FIG. 10, the cross-section 41 measured within the respective recess 38 is also designated 41₁. The significantly smaller cross-section 41 within the constriction 40 is also designated 41₂.

In FIGS. 1 through 10, the heat exchanger 1 is designed as a cross-flow heat exchanger 1, such that the first flow channels 9 pass through the heat exchanger block 2 in the block longitudinal direction X and fluidically connect an inflow side 10 of the heat exchanger block 2 exposed to the first fluid with an outflow side 12 of the heat exchanger block 2 ex-posed to the first fluid.

Furthermore, in the example shown in FIGS. 1 through 10, the first chamber 4 forms a distributor chamber 4 and has the supply connection 5, while the second chamber 7 forms a collector chamber 7 and has the discharge connection 8.

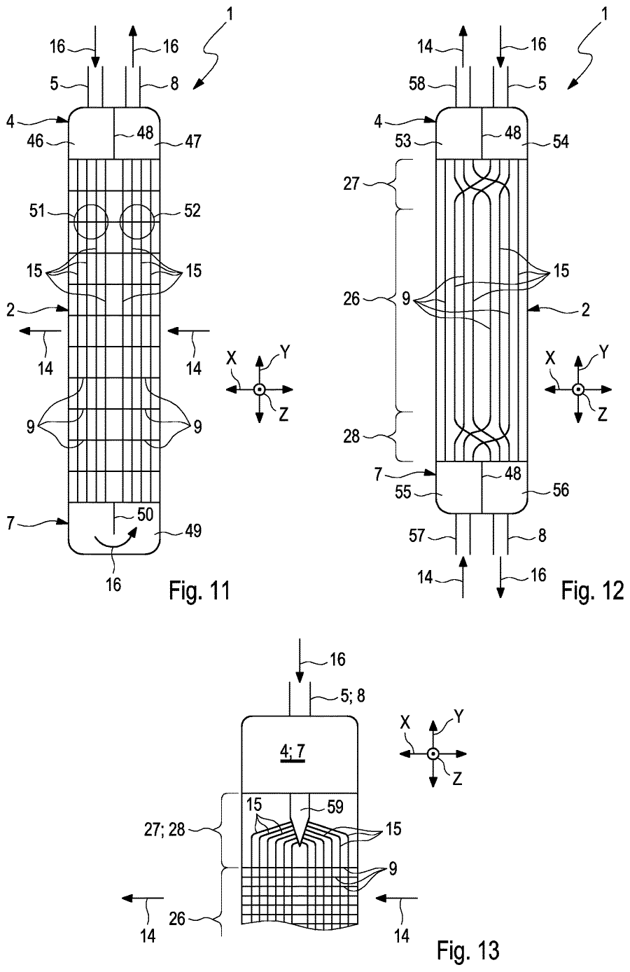

FIG. 11 now shows, purely as an example and in a greatly simplified form, another embodiment in which the first chamber 4 has or forms a distributor chamber 46 and a collector chamber 47. This can be achieved, for example, by means of a partition wall 48, which divides the first chamber 4 to form the distributor chamber 46 and the collector chamber 47 therein. The first connection 5 is then formed on the distributor chamber 46 and forms a supply connection 5, while the second connection 8 is formed on the collector chamber 47 and forms a discharge connection 8. In this case, the second chamber 7 forms a deflection chamber 49. For example, a web 50 can be formed in the second chamber 7 for this purpose, which guides or supports the flow deflection of the second fluid in the deflection chamber 49. A first group 51 of a plurality of second flow channels 15 connects the distributor chamber 46 to the deflection chamber 49. A second group 52 of a plurality of second flow channels 15 connects the deflection chamber 49 to the collector chamber 47.

In another alternative embodiment, which is shown in FIG. 12 in a purely exemplary and greatly simplified form, the heat exchanger 1 can, on the other hand, be designed as a parallel-flow heat exchanger 1, in which the first flow channels 9 pass through the heat exchanger block 2 in the block transverse direction Y. In particular, it may be provided that first flow channels 9 and second flow channels 15 alternate in the heat exchanger block 2 in the block height direction Z and/or in the block longitudinal direction X. FIG. 12 shows how, in the central transverse region 26, first flow channels 9 and second flow channels 15 alternate in the block longitudinal direction X and cross each other in the transition regions 27, 28 with the media separated.

Furthermore, in the embodiment as a parallel-flow heat exchanger 1 according to FIG. 12, it may be provided that the first chamber 4 has or forms a first sub-chamber 53 and a second sub-chamber 54, wherein the first sub-chamber 53 is fluidically connected to the first flow channels 9, while the second sub-chamber 54 is fluidically connected to the second flow channels 15. In addition, the second chamber 7 may have or form a third sub-chamber 55 and a fourth sub-chamber 56, wherein the third sub-chamber 55 is fluidically connected to the first flow channels 9, while the fourth sub-chamber 56 is fluidically connected to the second flow channels 15.

Optionally, as shown in FIG. 12, it may also be provided that the first sub-chamber 53 forms a collector chamber 53 for the first flow channels 9, that the second sub-chamber 54 forms a distributor chamber 54 for the second flow channels 15, that the third sub-chamber 55 forms a distributor chamber 55 for the first flow channels 9, and that the fourth sub-chamber 56 forms a collector chamber 7 for the second flow channels 15. The first connection 5 serves as a supply connection 5 for the second fluid and is formed on the second sub-chamber. The second connection 8 serves as a discharge connection 8 for the second fluid and is formed on the fourth sub-chamber 56. A third connection 57 serves as a supply connection 57 for the first fluid and is formed on the third sub-chamber 55. A fourth connection 58 serves as a discharge connection 58 for the first fluid and is formed on the first sub-chamber 53.

If the heat exchanger 1 is designed as a parallel-flow heat exchanger 1, all of the embodiments and features described above in FIGS. 1 through 10 that relate to the second flow channels 15 can also be implemented in a corresponding manner in the first flow channels 9.

This applies in particular to the geometric embodiments of the openings that open into the respective chamber 4, 7 or sub-chamber 53, 54, 55, 56, and/or for varying the flowable cross-sections in the block transverse direction Y within the flow channels 9, 15 and in the block longitudinal direction X in adjacent flow channels 9, 15. In particular, the first flow channels 9 in the heat exchanger block 2 can therefore also form longitudinal rows of channels with a plurality of first flow channels 9 adjacent in the block longitudinal direction X, wherein a plurality of such longitudinal rows of channels are adjacent in the block height direction Z.

In principle, according to FIGS. 1 through 12, an embodiment is preferred in which the second flow channels 15 of the respective longitudinal row of channels 17 extend separately from the first chamber 4 to the second chamber 7 and there have separate inlet openings 19 and separate outlet openings 23. In another embodiment, which is shown in FIG. 13 as a purely exemplary and greatly simplified illustration, it may be provided that the second flow channels 15 of the respective longitudinal row of channels 17 run separately from one another, at least in the central transverse region 26 of the heat exchanger block 2, while they are combined into a common channel 59 in the first transition region 27 of the heat exchanger block 2 and/or in the second transition region 28 of the heat exchanger block 2.

1. An additively manufactured heat exchanger for media-separated heat transfer between a first fluid and a second fluid, comprising:
an additively manufactured heat exchanger block that has a block longitudinal direction, a block transverse direction, and a block height direction that are perpendicular to each other,
a plurality of first flow channels for conducting the first fluid disposed in the heat transfer block and penetrate the heat exchanger block,
a first chamber disposed on the heat exchanger block at a first transverse end, the first transverse end extends in the block height direction,
a second chamber disposed on the heat exchanger block at a second transverse end that is turned away from the first transverse end in the block transverse direction and extends in the block height direction,
a plurality of second flow channels for conducting the second fluid disposed in the heat exchanger block, the plurality of second flow channels fluidically separated from the plurality of first flow channels that penetrate the heat exchanger block in the block transverse direction and fluidically connect the first chamber to the second chamber,
a first connection for supplying or discharging the second fluid and a second connection for discharging or supplying the second fluid,
wherein the plurality of second flow channels are arranged next to one another in the block longitudinal direction and form a longitudinal row of channels, and
wherein a plurality of longitudinal rows of channels are arranged next to one another in the block height direction within the heat exchanger block.

2-23. (canceled)

24. The heat exchanger according to claim 1, wherein:
the heat exchanger block has a block longitudinal center plane extending transversely to the block longitudinal direction, and
the plurality of second flow channels are configured with respect to their flow resistance such that, in the respective longitudinal row of channels, a magnitude of the flow resistance of the respective second flow channel correlates with a distance of the respective second flow channel from the block longitudinal center plane, such that second flow channels of the plurality of second flow channels that are at a greater distance from the block longitudinal center plane have a greater flow resistance than other second flow channels of the plurality of second flow channels that are at a smaller distance from the block longitudinal center plane.

25. The heat exchanger according to claim 1, wherein:
the heat exchanger block has a block longitudinal center plane extending transversely to the block longitudinal direction, and
the plurality of second flow channels are configured with regard to their flowable cross-sectional area such that in the respective channel longitudinal row, a size of the flowable cross-sectional area of the respective second flow channel correlates with a distance of the respective second flow channel from the block longitudinal center plane, such that second flow channels of the plurality of second flow channels that are at a greater distance from the block longitudinal center plane have a smaller flowable cross-sectional area than other second flow channels of the plurality of second flow channels that are at a smaller distance from the block longitudinal center plane.

26. The heat exchanger according to claim 25, wherein:
the heat exchanger block has a central transverse region that is spaced apart from the first transverse end and the second transverse end, and
the plurality of second flow channels are configured with regard to their flowable cross-sectional area such that, at least in the middle transverse area in the respective channel longitudinal row, the size of the flowable cross-sectional area of the respective second flow channel correlates with the distance of the respective second flow channel from the block longitudinal center plane, so that the second flow channels that are at the greater distance from the block longitudinal center plane have a smaller flowable cross-sectional area than the other second flow channels that are at the smaller distance from the block longitudinal center plane.

27. The heat exchanger according to claim 1, wherein:
the heat exchanger block has a central transverse region that is spaced apart from the first transverse end and the second transverse end, and
the plurality of second flow channels have a flowable cross-sectional area that decreases from a first opening at the first chamber to the central transverse region and/or increases from the central transverse region to a second opening into the second chamber.

28. The heat exchanger according to claim 1, wherein:
the heat exchanger block has a central transverse region that is spaced apart from the first transverse end and the second transverse end,
the heat exchanger block has a first transition region at the first transverse end that connects the first chamber to the central transverse region, and a second transition region at the second transverse end that connects the second chamber to the central transverse region,
the heat exchanger block has a block longitudinal center plane extending transversely to the block longitudinal direction,
the plurality of second flow channels in the central transverse region run parallel to the block transverse direction, and
the plurality of second flow channels, which are spaced apart from or turned away from the block longitudinal center plane, run at an angle to the block transverse direction in the first transition region and/or in the second transition region, an inclination increasing from the central transverse region to the first chamber and/or to the second chamber.

29. The heat exchanger according to claim 1, wherein:
the heat exchanger block has a central transverse region that is spaced apart from the first transverse end and the second transverse end,
the heat exchanger block has a first transition region at the first transverse end that connects the first chamber to the central transverse region, and a second transition region at the second transverse end that connects the second chamber to the central transverse region,
the heat exchanger block has a block longitudinal center plane extending transversely to the block longitudinal direction, and
at least the second flow channels, which are spaced apart from or turned away from the block longitudinal center plane, have a varying opening cross-section in the first transition region and/or in the second transition region along the block transverse direction.

30. The heat exchanger according to claim 29, wherein:
at least the second flow channels, which are spaced apart from or turned away from the block longitudinal center plane, have a constant opening cross-section along the block transverse direction in the central transverse region.

31. The heat exchanger according to claim 29, wherein:
at least the second flow channels, which are spaced apart or remote from the block longitudinal center plane, have an elliptical opening cross-section in a first opening into the first chamber, the elliptical opening cross-section of the first opening being elongated in the block longitudinal direction and merges into a circular opening cross-section along the block transverse direction within the first transition region up to the central transverse region, and/or
at least the second flow channels, which are spaced apart from or turned away from the block longitudinal center plane, have an elliptical opening cross-section in a second opening into the second chamber, is the elliptical opening cross-section of the second opening being elongated in the block longitudinal direction and merges into a circular opening cross-section along the block transverse direction within the second transition region up to the central transverse region.

32. The heat exchanger according to claim 1, wherein:
the first chamber forms or has a distributor chamber that supplies the second fluid to the plurality of second flow channels,
the first connection is disposed on the distributor chamber and forms a supply connection for supplying the second fluid to the distributor chamber, and
the distributor chamber has a profile on a distributor side facing the plurality of second flow channels which runs transversely to the block height direction and is concave toward an interior of the distributor chamber.

33. The heat exchanger according to claim 1, wherein:
the second chamber forms or has a collector chamber that receives the second fluid coming from the plurality of second flow channels,
the second connection is disposed on the collector chamber and forms a discharge connection for discharging the second fluid from the collector chamber, and
the collector chamber has a profile on a collector side facing the plurality of second flow channels which runs transversely to the block height direction and is concave toward an interior of the collector chamber.

34. The heat exchanger according to claim 1, wherein:
in at least some of or in all of the plurality of second flow channels, ribs or nubs protrude into a flowable cross-section so that the ribs or nubs can be flowed onto and/or flowed around by the second fluid.

35. The heat exchanger according to claim 1, wherein:
in at least some of or in all of the plurality of first flow channels, ribs or nubs protrude into a flowable cross-section so that the ribs or nubs can be flowed onto and/or flowed around by the first fluid.

36. The heat exchanger according to claim 34, wherein:
the ribs are structured in a helical manner such that the ribs extend in a screw-like manner along the respective second flow channel.

37. The heat exchanger according to claim 1, wherein:
the first chamber or the second chamber has recesses on an inner side exposed to the second fluid to increase a surface area of the inner side.

38. The heat exchanger according claim 1, wherein:
at least some of or all of the plurality of second flow channels have recesses on an inner side exposed to the second fluid, at least in a transition region of the heat exchanger block adjacent to the first chamber or the second chamber, to increase a surface area of the inner side.

39. The heat exchanger according to claim 37, wherein:
the recesses at the transition to the inner side have a constriction such that a cross-section of the respective recess running transversely to a normal direction of the inner side is larger within the respective recess than in the constriction.

40. The heat exchanger according to claim 1, wherein:
the first chamber has or forms a distributor chamber and a collector chamber,
the first connection is disposed on the distributor chamber and forms a supply connection,
the second connection is disposed on the collector chamber and forms a discharge connection, and
the second chamber forms a deflection chamber.

41. The heat exchanger according to claim 1, wherein:
the heat exchanger is configured as a cross-flow heat exchanger, and
the plurality of first flow channels pass through the heat exchanger block in the block longitudinal direction and fluidically connect an inflow side of the heat exchanger block exposed to the first fluid with an outflow side of the heat exchanger block exposed to the first fluid.

42. The heat exchanger according to claim 41, wherein:
at least some of the plurality of first flow channels are arranged next to one another in the heat exchanger block in the block transverse direction and form a transverse row of channels,
a plurality of transverse rows of channels are arranged next to each other in the block height direction within the heat exchanger block,
the heat exchanger block has a central height range that is spaced apart from lateral block ends which are turned away from one another in the block height direction, and
the plurality of transverse rows of channels are each passed through the heat exchanger block between two adjacent longitudinal rows of channels, at least in the central height range of the heat exchanger block.

43. The heat exchanger according to claim 1, wherein:
the heat exchanger is configured as a parallel-flow heat exchanger,
the plurality of first flow channels pass through the heat exchanger block in the block transverse direction, and
in the heat exchanger block, the plurality of first flow channels and the plurality of second flow channels alternate in the block height direction and/or in the block longitudinal direction.

44. The heat exchanger according to claim 43, wherein:
the first chamber has or forms a first sub-chamber and a second sub-chamber,
the first sub-chamber is fluidically connected to the plurality of first flow channels, and the second sub-chamber is fluidically connected to the plurality of second flow channels,
the second chamber has or forms a third sub-chamber and a fourth sub-chamber, and
the third sub-chamber is fluidically connected to the plurality of first flow channels, and the fourth sub-chamber is fluidically connected to the plurality of second flow channels.

45. The heat exchanger according to claim 44, wherein:
the first sub-chamber forms a collector chamber for the plurality of first flow channels,
the second sub-chamber forms a distributor chamber for the plurality of second flow channels,
the third sub-chamber forms a distributor chamber for the plurality of first flow channels, and
the fourth sub-chamber forms a collector chamber for the plurality of second flow channels.
